(19) United States
(12) Patent Application Publication
(10) Pub. No.: US 2013/0124052 A1
(43) Pub. Date: May 16, 2013

(54) METHOD FOR OPERATING A MOTOR VEHICLE SAFETY SYSTEM AND A SAFETY SYSTEM FOR A MOTOR VEHICLE

(71) Applicant: GM GLOBAL TECHNOLOGY OPERATIONS LLC, Detroit, MI (US)

(72) Inventor: Uwe Hahne, Buettelborn (DE)

(73) Assignee: GM GLOBAL TECHNOLOGY OPERATIONS LLC, Detroit, MI (US)

(21) Appl. No.: 13/670,514

(22) Filed: Nov. 7, 2012

(30) Foreign Application Priority Data
Nov. 10, 2011 (DE) 10 2011 118 149.4

(51) Int. Cl. B60R 21/013

(52) U.S. Cl. CPC B60R 21/013
USPC 701/46

(57) ABSTRACT

A method for operating a safety system in a motor vehicle is provided. The method includes ascertaining at least one parameter characterizing a traffic situation of the motor vehicle and classifying a momentary traffic situation of the motor vehicle based on the at least one ascertained parameter. The method includes ascertaining a probability of an occurrence of at least one accident type from a plurality of predefined accident types in the classified momentary traffic situation, and if the ascertained probability exceeds a predefined threshold value, adapting a triggering threshold for actuating at least one passenger protection device of the motor vehicle.

### CROSS-REFERENCE TO RELATED APPLICATION

This application claims priority to German Patent Application No. 10 2011 118 149.4, filed Nov. 10, 2011, which is incorporated herein by reference in its entirety.

### TECHNICAL FIELD

The present disclosure relates to a method for operating a safety system in a motor vehicle, a safety system for a motor vehicle, a computer program product and a computer-readable medium.

### BACKGROUND

The DE 101 28 141 C2 has disclosed a vehicle safety arrangement with a first subsystem provided in the vehicle for controlling a first operating function of the vehicle and for generating a signal predicting an impending potential crash of the vehicle. In addition the vehicle safety arrangement comprises a second subsystem provided in the vehicle for controlling a second operating function of the vehicle and a control provided in the vehicle for receiving the prediction signal and for altering the operation of the second subsystem in order to prepare the vehicle for the crash. A height adjustment of the adjustable driving height is effected via the second subsystem.

Accordingly, it may be desirable to provide a method for operating a safety system of a vehicle, a safety system for a vehicle, a computer program product and a computer-readable medium offering further improved protection for passengers. In addition, other objects, desirable features and characteristics will become apparent from the subsequent summary and detailed description, and the appended claims, taken in conjunction with the accompanying drawings and this background.

### SUMMARY

According to one of various aspects of the present disclosure a method for operating a safety system in a motor vehicle comprises ascertaining at least one parameter characterizing a traffic situation of the motor vehicle, and classifying a momentary traffic situation of the motor vehicle based on the at least one ascertained parameter. The method also includes further ascertaining a probability for an occurrence of at least one accident type from a plurality of predefined accident types in the classified momentary traffic situation. If the ascertained probability exceeds a predefined threshold value, the method includes adapting a triggering threshold for actuating at least one passenger protection device of the motor vehicle.

The method according to the above exemplary embodiment permits further improved passenger protection. This is accomplished by classifying the momentary traffic situation of the motor vehicle and by ascertaining the probability for an occurrence of at least one accident type from a plurality of predefined accident types and by adapting the triggering threshold for actuating of the at least one passenger protection device of the motor vehicle. By classifying the momentary traffic situation and ascertaining the probability for an occurrence of a particular accident type in the classified momentary traffic situation, triggering of the passenger protection device can thus be adapted in an advantageous manner to the respective traffic situation. By specifying a plurality of predefined accident types a substantially matching possible accident situation can thus be determined.

In one example, this involves ascertaining a probability for an occurrence of an accident type for all of the plurality of predefined accident types in the classified current accident situation, i.e. the probability for an occurrence of each type in the classified current accident situation is ascertained for each of the predefined accident types. This allows the probability for an occurrence of an accident in the momentary accident situation to be determined in a very comprehensive way.

In another exemplary embodiment, adapting of the triggering threshold is effected such that actuation of the at least one passenger protection device is effected at an earlier point in time compared with the original triggering threshold. This is based on the consideration that for an ascertained increased probability for the occurrence of an accident situation, an earlier activation of the passenger protection device could minimize the possible consequences of the accident for the passengers of the motor vehicle.

The majority of predefined accident types generally includes at least one element selected from the group comprising a frontal collision, a rear-end impact, a lateral collision, a rear-end accident, a skidding accident, an accident with a stationary object, a collision with a pedestrian, an accident involving wildlife, a rollover accident and a departure from the carriageway. These accident types represent traffic-typical kinds of accident situations. Therefore ascertaining the probability of an occurrence of such accident types is of special importance.

In another exemplary embodiment, the at least one passenger protection device of the motor vehicle is selected from the group comprising a belt tensioner, an airbag, in one example, a front air bag, a side airbag and/or a head airbag, an active head support system, a seat adjustment system, a foldable pedal set and a safety steering column. The active head support system is understood to be a head support arrangement, which in case of a collision is able to tilt in direction of the respective person in order to be able to protect the head of the person concerned at the earliest point in time. By means of an actuation of the seat adjustment system the body of the person concerned can then, for example in case of a rear-end impact, be caught up and thus slowed down. A foldable pedal set is understood to be an active pedal system which moves at least one of the pedals in case of a recognized accident, whereby the danger of injury to a driver of the motor vehicle can be reduced. These systems are thus suitable for the protection of the passengers in a selected way.

In another exemplary embodiment, an adaptation of an extent of actuation of the at least one passenger protection device of the motor vehicle is effected, in case the ascertained probability exceeds the predefined threshold value. Apart from the time of actuation, this also allows the strength of actuation of the passenger protection device, for example the force with which the passenger protection device is actuated, to be adapted to match the respective traffic situation in an advantageous manner.

Ascertaining at least one parameter can include ascertaining a type and/or nature of a carriageway over which the motor vehicle happens to currently drive. Further ascertaining the at least one parameter can additionally or alternatively include ascertaining a number of further road users present in the vicinity of the motor vehicle. A road user is understood from now on to be a person or a vehicle, which uses areas open for traffic purposes to the general public, independently of whether the person or the vehicle is moving or is stationary. These parameters make it possible to classify momentary traffic situations to a substantially accurate extent.

Ascertaining at least one parameter may be effected by means of data of at least one element of the motor vehicle selected from the group comprising an electromagnetic sensor, in one example, a radar sensor or a lidar sensor, an acoustic sensor, in one example, an ultrasound sensor, a rotational speed sensor, in one example, a yaw rate sensor, an acceleration sensor, an optical camera, a vehicle-to-vehicle communication device, a vehicle-to-infrastructure communication device and a driver assistance system, for example, a collision-avoiding or emergency braking system. These elements are now provided in motor vehicles to an increasing extent, thus enabling the number of components required for the method to be reduced in an advantageous manner.

In another exemplary embodiment, ascertaining the at least one parameter includes ascertaining a momentary position of the motor vehicle. Classifying the momentary traffic situation of the motor vehicle is effected in this exemplary embodiment based on the ascertained position and the map data stored in a storage device. The storage device is generally part of a navigation system of the motor vehicle which additionally can be designed for ascertaining the momentary position of the motor vehicle.

In addition the current weather conditions in the surrounding area of the motor vehicle and/or a time of day can be ascertained. In this exemplary embodiment, adaptation of the triggering threshold is effected depending upon the ascertained current weather conditions and/or the ascertained time of day. This is based on the consideration that the weather conditions and/or the time of day can also have an influence upon the occurrence of an accident situation. For example snow, ice or rain or bad visibility due to twilight or intense light can increase the probability of certain accident situations. Furthermore the probability of an accident involving wildlife at night may be increased.

In another exemplary embodiment of the method a type and/or speed of an object involved in a possible impending accident is additionally ascertained. Adaptation of the triggering threshold is effected in this exemplary embodiment depending upon the ascertained type and/or speed of the object. This allows the possible accident consequences for the passengers of the motor vehicle to be further reduced in an advantageous manner.

Moreover, an alignment of the motor vehicle with a currently driven-over carriageway can be ascertained. Adaptation of the triggering threshold is effected in this exemplary embodiment depending additionally upon the ascertained alignment of the motor vehicle. For example, if the motor vehicle is aligned at right angles to the carriageway there is an increased probability of a side impact or a lateral collision with an object and the triggering threshold for actuation of at least one side airbag can be lowered or reduced accordingly.

The present disclosure further relates to a safety system for a motor vehicle, wherein the safety system comprises a first ascertainment device designed to ascertain at least one parameter characterizing a traffic situation of the motor vehicle. In addition the safety system comprises a classification device designed to classify a momentary traffic situation of the motor vehicle based on the at least one ascertained parameter. Furthermore the safety system comprises a second ascertainment device designed to ascertain a probability for the occurrence of at least one accident type from a plurality of predefined accident types in the classified momentary traffic situation. Further the safety system comprises an adaptation device designed to adapt a triggering threshold for actuating at least one passenger protection device of the motor vehicle in case the ascertained probability exceeds a predefined threshold value.

The safety system according to the present disclosure comprises the advantages already mentioned in the context of the method according to the present disclosure which therefore will not cited again at this point in order to avoid repetitions.

Further the present disclosure relates to a computer program product which when executed on a computer unit of a safety system of a motor vehicle, instructs the computer unit to execute the following routine. The computer unit is instructed to ascertain at least one parameter characterizing a traffic situation of the motor vehicle. In addition the computer unit is instructed to classify a momentary traffic situation of a motor vehicle based on the at least one ascertained parameter. In addition the computer unit is instructed to ascertain a probability for the occurrence of at least one accident type from a plurality of predefined accident types in the classified momentary traffic situation. In case the ascertained probability exceeds a predefined threshold value, the computer unit is instructed to adapt a triggering threshold for actuating at least one passenger protection device of the motor vehicle.

In addition the present disclosure relates to a computer-readable medium on which a computer program product according to the exemplary embodiment is stored.

The computer program product and the computer-readable medium according to the present disclosure comprise the advantages already mentioned in the context of the method according to the present disclosure, which therefore will not be cited again at this point in order to avoid repetitions.

In the above mentioned exemplary embodiments the motor vehicle may for example be a passenger car or a truck.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for operating a safety system of a motor vehicle according an exemplary embodiment of the present disclosure;

FIG. 2 shows a flow diagram of a method for operating a safety system of a motor vehicle according another exemplary embodiment of the present disclosure;

FIG. 3 shows a flow diagram of a method for operating a safety system of a motor vehicle according another exemplary embodiment of the present disclosure;

FIG. 4 shows a flow diagram of a method for operating a safety system of a motor vehicle according another exemplary embodiment of the present disclosure;

FIG. 5 shows a flow diagram of a method for operating a safety system of a motor vehicle according an exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

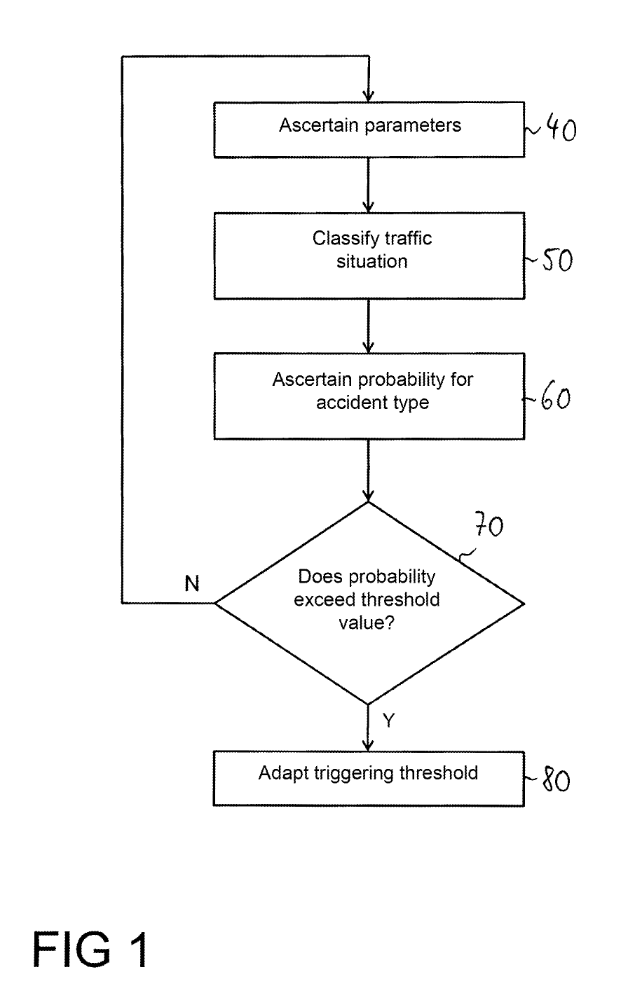

FIG. 1 shows a flow diagram of a method for operating a safety system of a motor vehicle according to an exemplary embodiment of the present disclosure. The motor vehicle may be, for example, a passenger car or a truck.

In 40 at least one parameter characterizing a traffic situation of a motor vehicle is ascertained. Ascertaining the least one parameter may include ascertaining a type and/or nature of a carriageway over which the motor vehicle is currently driving. Additionally or alternatively ascertaining the at least one parameter may include ascertaining the at least one parameter for ascertaining a number of further road users in the vicinity of the motor vehicle.

Ascertaining the at least one parameter is generally effected by means of data from at least one element of the motor vehicle, selected from the group comprising an electromagnetic sensor, an acoustic sensor, a rotational speed sensor, an acceleration sensor, an optical camera, a vehicle-to-vehicle communication device, a vehicle-to-infrastructure communication device and a driver assistance system.

Furthermore ascertaining the at least one parameter may include ascertaining a current position of the motor vehicle by means of a position ascertainment device, wherein the position ascertainment device is generally part of a navigations system of the motor vehicle.

In 50 classifying a momentary traffic situation of the motor vehicle is effected based on the at least one ascertained parameter. Classifying a momentary traffic situation may include a classification according to the currently driven-over type of carriageway. Furthermore the momentary traffic situation may be classified according to whether the motor vehicle is inside or outside a town or village.

In 60 the probability for an occurrence of at least one accident type is ascertained from a plurality of predefined accident types in the classified momentary traffic situation. Generally, ascertaining a probability for an occurrence of an accident type is effected for all of the plurality of predefined accident types.

The plurality of predefined accident types, in the exemplary embodiment shown, includes at least one element, selected from the group comprising a frontal collision, a lateral collision, a rear-end accident, a skidding accident, an accident involving wildlife, a vehicle rollover and a departure of the vehicle from the carriageway.

For example a lateral collision occurs typically more frequently at intersections and in town traffic. And a rear-end accident is more probable in a traffic jam than a lateral accident.

Furthermore ascertaining the probability may be affected based on accident statistics, which generally are transferred to the vehicle by means of a vehicle-to-vehicle communication device and/or a vehicle-to-infrastructure communication device of the same. In addition the accident statistics may be stored in map data filed in a storage device. For example the probability of accidents with pedestrians may be increased on a main road through a town at a road crossing. Furthermore frontal collisions could increasingly happen at a section of a country road due to frequently performed risky overtaking maneuvers.

In 70 it is ascertained whether the probability or probabilities ascertained respectively exceed a predefined threshold value.

If the ascertained probability for the occurrence of the accident type or types does not exceed the respective threshold value, 40, 50, 60 and 70 are repeated in the exemplary embodiment shown.

If it is ascertained in 70, however, that the probability or one of the ascertained probabilities exceeds the respective predefines threshold value, an adaption of the at least one triggering threshold for actuating at least one passenger protection device of the motor vehicle is effected in 80.

Adaptation of the at least one triggering threshold is effected in the exemplary embodiment shown such that an actuation of the at least one passenger protection device is effected at an earlier point in time. In one example, adaptation of the at least one triggering threshold may be effected in that actuation of the at least one passenger protection device is effected immediately.

The at least one passenger protection device is generally selected from the group comprising a belt tensioner, an airbag, in one example, a front airbag or at least one side airbag, an active head support system, a seat adjustment system, a foldable pedal set and a safety steering column. Adaptation of the triggering threshold for a multi-stage airbag, for example a two-stage airbag, may be effected in one example, in such a way that only certain stages of the airbag are actuated.

Thereafter it may be ascertained based on the adapted triggering threshold as to whether actuating the at least one passenger protection device is necessary or may be waived. To this end corresponding parameters, for example a current value of an acceleration or slowing-down of the motor vehicle, can be ascertained by means of sensors designed for this purpose and compared with the adapted triggering threshold.

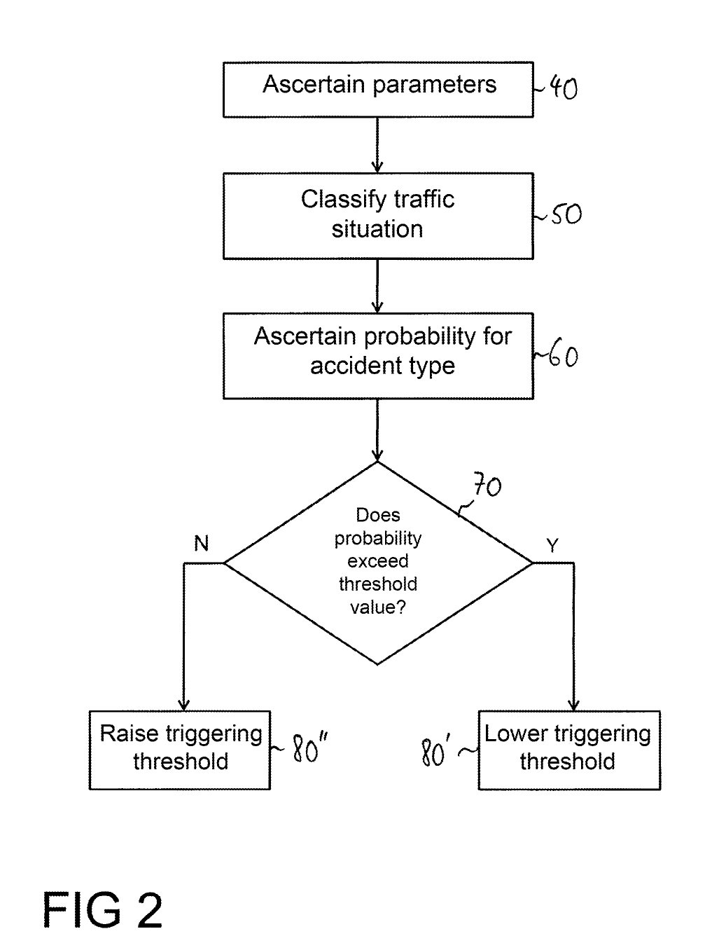

FIG. 2 shows a flow diagram of a method for operating a safety system of a motor vehicle according to another exemplary embodiment of the present disclosure. The motor vehicle may be, for example, again a passenger car or a truck.

In 40 at least one parameter characterizing a traffic situation of a motor vehicle is ascertained. Then in 50 a momentary traffic situation of a motor vehicle is classified based on the at least one ascertained parameter. 40 and 50 correspond to 40 and 50 of the exemplary embodiment shown in FIG. 1.

In 60 a probability for an occurrence of at least one accident type from a plurality of predefined accident types in the classified momentary traffic situation is ascertained corresponding to 60 of the exemplary embodiment shown in FIG. 1.

In 70 it is determined as to whether the ascertained probability exceeds a predefined threshold value.

In the exemplary embodiment shown, in case the ascertained probability exceeds the predefined threshold value, a triggering threshold for actuating at least one passenger protection device of the motor vehicle is then lowered in 80′. Actuation of the at least one passenger protection device is then effected in this case at an earlier point in time compared to an actuation based on the original triggering threshold.

If on the other hand, the ascertained probability does not exceed the predefined threshold value, then in the exemplary embodiment shown the triggering threshold for actuating the at least one passenger protection device of the motor vehicle is raised in 80″. This can be effected, in one example, in that the passenger protection device in the classified traffic situation is not triggered. In this way erroneous triggering of the passenger protection device can be avoided in an improved manner.

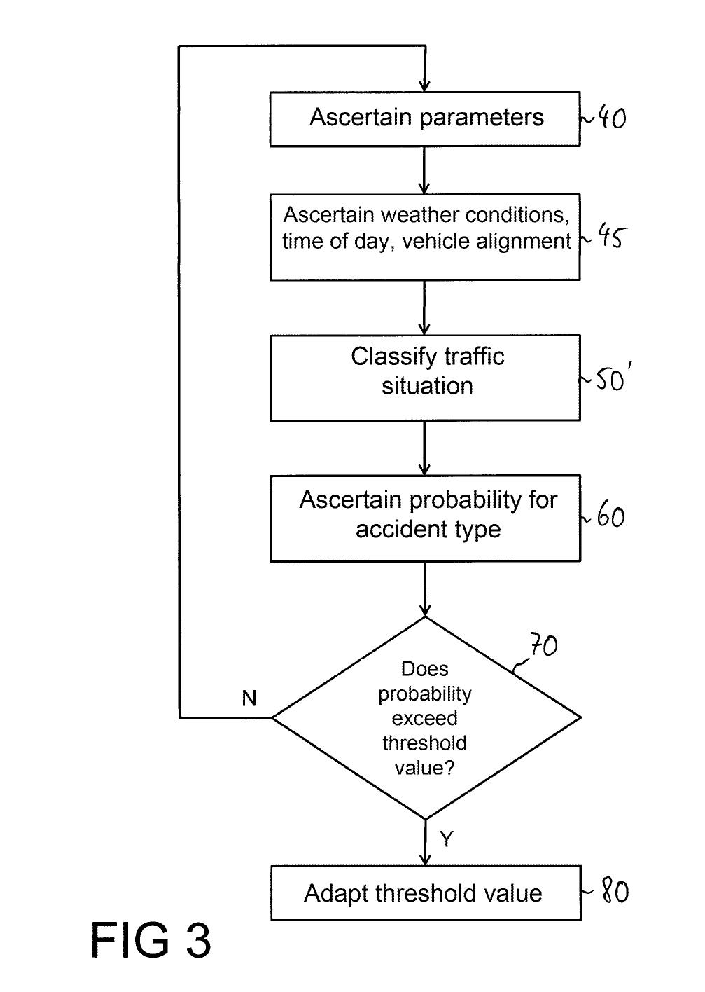

FIG. 3 shows a flow diagram of a method for operating a safety system of a motor vehicle according another exemplary embodiment of the present disclosure. The motor vehicle may, for example, be a passenger car or a truck.

In 40 at least one parameter characterizing a traffic situation of the motor vehicle is ascertained corresponding to 40 of the exemplary embodiment shown in FIG. 1.

Furthermore in 45 ascertaining the current weather conditions in the vicinity of the motor vehicle and/or a time of day and/or an alignment of the motor vehicle with a currently driven-over carriageway is effected.

The current weather conditions are ascertained by means of data ascertained by at least one sensor, for example by means of data ascertained by a rain sensor. The alignment of the motor vehicle in relation to the carriageway over which it is travelling is generally determined by means of evaluating photos taken by an optical camera of the motor vehicle.

In 50′ the momentary traffic situation of the motor vehicle is classified. This is effected in the shown exemplary embodiment based on the at least one ascertained parameter and based on the ascertained current weather conditions and/or the ascertained time of day and/or the ascertained alignment of the motor vehicle.

In 60 a probability for an occurrence of at least one accident type from a plurality of predefined accident types in the classified momentary traffic situation is ascertained, corresponding to 60 of the exemplary embodiment shown in FIG. 1.

In 70 it is determined, as to whether the ascertained probability exceeds a predefined threshold value.

If the probability does not exceed the predefined threshold value, 40, 45, 50′, 60 and 70 are repeated in the shown exemplary embodiment.

If on the other the ascertained probability exceeds the predefined threshold value, adapting a triggering threshold for actuating at least one passenger protection device of the motor vehicle is effected in 80. Adaptation of the triggering threshold is effected depending upon the ascertained probability and thus by taking into consideration the classified momentary traffic situation, and in addition depending upon the ascertained current weather conditions and/or the ascertained time of day and/or the ascertained alignment of the motor vehicle.

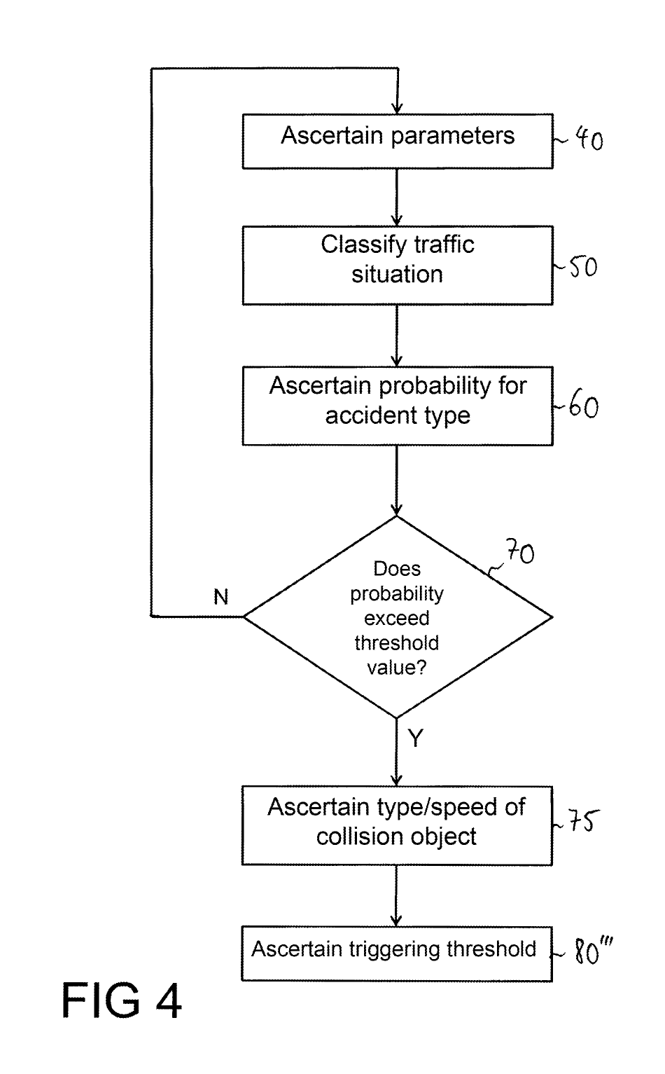

FIG. 4 shows a flow diagram of a method for operating a safety system according to another exemplary of the present disclosure. The motor vehicle may, for example, again be a passenger car or a truck.

In 40 at least one parameter is ascertained which characterizes a traffic situation of a motor vehicle. Furthermore, in 50 a momentary traffic situation of the motor is classified based on the at least one ascertained parameter. 40 and 50 correspond to 40 and 50 of the exemplary embodiment shown in FIG. 1.

In 60 a probability for an occurrence of at least one accident type from a plurality of predefined accident types in the classified momentary traffic situation is additionally ascertained corresponding to 60 of the exemplary embodiment shown in FIG. 1.

Further a determination is made in 70 as to whether the ascertained probability exceeds a predefined threshold value.

In case the ascertained probability does not exceed the predefined threshold value, 40, 50, 60 and 70 are repeated in the shown exemplary embodiment.

In case, however, the ascertained probability does exceed the predefined threshold value, a type and/or a speed of an object involved in a possible impending accident is ascertained in the shown exemplary embodiment in 75. This may be effected, for example, by means of data ascertained by at least one environmental sensor of the motor vehicle, in one example, by means of data ascertained by a radar sensor, a lidar sensor, an ultrasound sensor and/or an optical camera.

In 80″ adaptation of a triggering threshold for actuating at least one passenger protection device of the motor vehicle is effected. In the shown exemplary embodiment this is effected depending upon the classified traffic situation as well as depending upon the ascertained type and/or speed of the object involved in a possible impending accident.

By means of the shown exemplary embodiment protection devices for the vehicle passengers may be activated according to the respective accident situation in order to avoid or minimize any injuries to the passengers.

To this end the threshold values of passive protection devices such as airbag systems and belt tensioners are altered on the basis of the ascertained accident type. Ascertaining the accident type is effected generally with the aid of environmental sensors and GPS data which can forecast the type of accident before the accident happens. It is, for example, feasible for the environmental sensors to forecast a frontal collision with the oncoming traffic. With the aid of this data the airbag system could lower the triggering criteria temporarily for the detection of a frontal collision in order to thereby achieve an earlier activation.

Also, the environmental sensors could inform the passive protection device of the object and the speed of the object to be involved in the expected accident. In this case also the threshold values could be adapted in a simple way, in order to minimize the consequences of the accident for the passengers of the vehicle.

Another one of various aspects of the present disclosure comprises determining the type of accident on the basis of the type of road and using this to configure the protection device. For example, a frontal crash with oncoming traffic or a lateral crash is typically less probable on a motorway and this could be taken into consideration in the parameters. On the other hand a lateral collision would typically take place more frequently at intersections and in town traffic. Also in a traffic jam a rear-end accident is more probable than a lateral accident. The probability for an accident involving wildlife is typically increased on country roads and at night. In this case also, the parameters can be set such that the consequences of a collision with animals are reduced at a further improved rate.

In another exemplary embodiment, the alignment of the vehicle to the carriageway is used to alter the threshold values for triggering protection devices. A vehicle standing at right angles to the motorway or even facing in the opposite direction of driving represent situations in which the threshold values can be distinctly lowered.

In one example, a protection device may be activated based merely on environmental sensors if it is ensured based on data ascertained by means of environmental sensors that a moving object will collide with the vehicle. An example for this situation would be where the vehicle following a skidding accident comes to a standstill at right angles to the carriageway and an environmental sensor recognizes that a vehicle is approaching.

By means of the shown exemplary embodiments calibration of a passenger protection device can thus be altered prior to an accident. In one example, this may be effected by altering parameters of the passenger protection systems solely based on the traffic situation. One example would be driving across a zebra crossing which would point to the potential danger of colliding with a pedestrian. Also when driving across a red traffic light, a railway crossing or a stop sign, the system may be calibrated to match a possible lateral collision.

In addition, if a traffic sign recognition system detects a zebra crossing, and/or digital map data provides to the passive safety system the information that the vehicle is in a town, the parameters for a pedestrian protection system could be calibrated for an earlier activation time. In motorway situations the parameters could be calibrated for a later point in time in order to avoid miscalculations.

In addition it is possible to set the threshold value for a lateral airbag sensor to an earlier activation time in the vicinity of intersections or following a skidding accident.

Also on motorways the systems can calibrated for possible rear-end collisions and on country roads, for possible oncoming traffic and thus for frontal collisions.

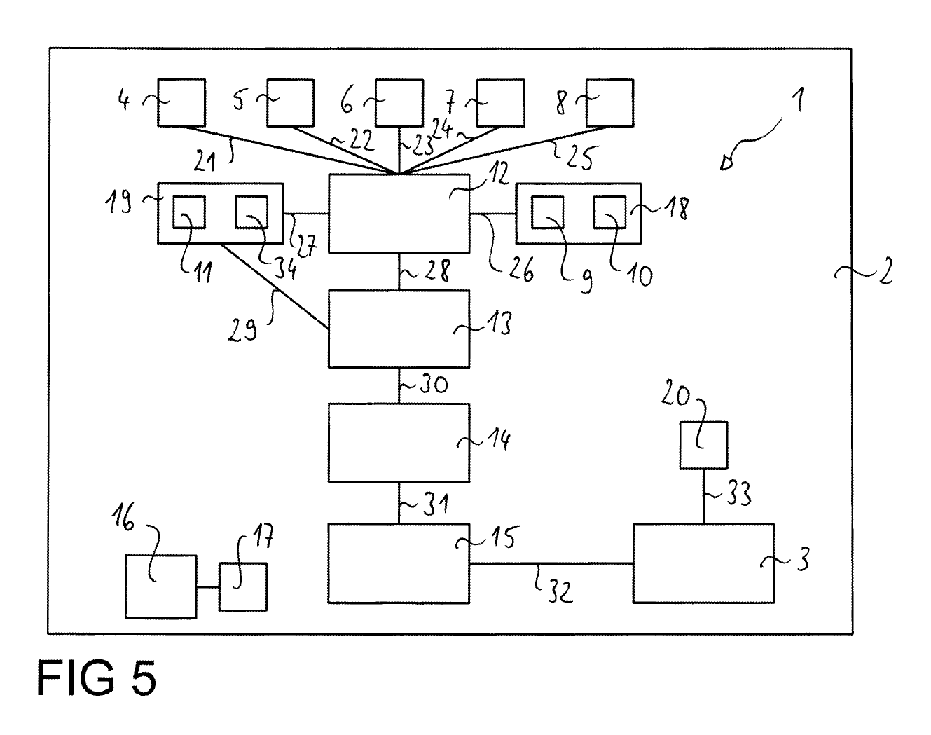

FIG. 5 shows a safety system 1 for a schematically shown motor vehicle 2 according to an exemplary embodiment of the present disclosure. The motor vehicle 2 may, for example, be a passenger car or a truck.

The safety system 1 comprises a first ascertainment device 12 designed to ascertain at least one parameter characterizing a traffic situation of motor vehicle 2.

In the exemplary embodiment shown the first ascertainment device 12 is connected via a signal line 21 with an electromagnetic sensor 4, for example a radar sensor or a lidar sensor, and via a signal line 22 it is connected with an acoustic sensor 5, for example an ultrasound sensor. Further, the first ascertainment device 12 is connected via a signal line 23 with a rotational speed sensor 6, for example a yaw rate sensor, and via a signal line 24 it is connected via a signal line 24 with an acceleration sensor 7. Further, the first ascertainment device 12 is connected via a signal line 25 with an optical camera 8 as well as via a signal line 26 with a communication unit 18 of the motor vehicle 2. The communication unit 18 of motor vehicle 2 includes a vehicle-to-vehicle communication device 9 as well as a vehicle-to-infrastructure communication device 10. Moreover the first ascertainment device 12 is connected, via a signal line 27, with a navigation system 19 of motor vehicle 2. The navigation system 19 includes a position ascertainment device 34 as well as a storage device 11 with map data filed thereon.

In the exemplary embodiment shown, ascertaining the at least one parameter is thus effected by means of data of the said elements of motor vehicle 1.

Further the safety system 1 comprises a classification device 13 designed to classify a momentary traffic situation of motor vehicle 2 based on the at least one ascertained parameter. To this end the classification device 13 is connected, via a signal line 28, with the first ascertainment device 12 as well as via a signal line 29 with the navigation system 19. Classification of the momentary traffic situation may thus be effected based, in one example, on the ascertained position of motor vehicle 2 and on map data filed in the storage device 11.

Further the safety system 1 comprises a second ascertainment device 14 designed for ascertaining a probability for an occurrence of at least one accident type from a plurality of predefined accident types in the classified momentary traffic situation. Generally, the second ascertainment device 14 is designed to ascertain the probability for an occurrence of an accident type for all of the plurality of predefined accident types. To this end the second ascertainment device 14 is connected via a signal line 30 with the classification device 13.

Furthermore the safety system 1 comprises an adaptation device 15 designed to adapt at least one triggering threshold for actuating at least one passenger protection device 3 of motor vehicle 2, in case the ascertained probability exceeds a predefined threshold value. To this end the adaptation device 15 is connected, via a signal line 32, with the passenger protection device 3 which may, for example, be selected from the group comprising a belt tensioner, an airbag, an active head support system, a seat adjustment system, a foldable pedal set and a safety steering column.

Adaptation of the triggering threshold can be effected such that actuation of the at least one passenger protection device 3 is effected at an earlier point in time, in case the ascertained probability exceeds the predefined threshold value. Furthermore, the adaptation device 15 can be designed for increasing the triggering threshold, in case the ascertained probability does not exceed the predefined threshold value.

In addition the adaptation device 15 may be designed for adapting an extent of actuation of the passenger protection device 3, in one example, in case the ascertained probability exceeds the predefined threshold value.

The passenger protection device 3 is also connected via a signal line 33 with a sensor 20, wherein it is determined by means of data ascertained by means of sensor 20, whether an actuation of the passenger protection device is effected.

In the exemplary embodiment shown the safety system 1 also comprises a computer unit 16 and a computer-readable medium 17, wherein a computer program product is stored on the computer-readable medium 17, which product when executed on the computer unit 16, instructs the computer unit 16 to execute the routine mentioned in the context of the exemplary embodiments of the method according to present disclosure, in one example, the routine of the exemplary embodiments shown in FIGS. 1 to 4, by means of the elements mentioned therein. To this end the computer unit 16 is connected in a manner not shown in any detail directly or indirectly with the corresponding elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for operating a safety system of a motor vehicle, the method comprising:
ascertaining at least one parameter characterizing a traffic situation of the motor vehicle;
classifying a momentary traffic situation of the motor vehicle, based on the at least one ascertained parameter;
ascertaining a probability for an occurrence of at least one accident type from a plurality of predefined accident types in the classified momentary traffic situation; and
in case the ascertained probability exceeds a predefined threshold value, adapting a triggering threshold for actuating at least one triggering threshold of the motor vehicle.

2. The method according to claim 1, wherein ascertaining a probability for the occurrence of an accident type is effected for all of the plurality of predefined accident types in the classified momentary traffic situation.

3. The method according to claim 1, wherein adaptation of the triggering threshold is effected such that actuation of the at least one passenger protection device is effected at an earlier point in time.

4. The method according to claim 1, wherein the plurality of predefined accident types includes at least one element selected from the group comprising a frontal collision, a rear-end impact, a lateral collision, a rear-end accident, a skidding accident, an accident with a stationary object, a collision with a pedestrian, an accident involving wildlife, a rollover accident and a departure from the carriageway.

5. The method according to claim 3, wherein the at least one passenger protection device of the motor vehicle is selected from the group comprising a belt tensioner, an airbag, an active head support system, a seat adjustment system, a foldable pedal set and a safety steering column.

6. The method according to claim 3, wherein an extent of actuation of the at least one passenger protection device of the motor vehicle is effected in case the ascertained probability exceeds the predefined threshold value.

7. The method according to claim 1, wherein ascertaining the at least one parameter includes ascertaining at least one of a type and a nature of a carriageway currently driven over by the motor vehicle.

8. The method according to claim 1, wherein ascertaining the at least one parameter includes ascertaining a number of further road users in the vicinity of the motor vehicle.

9. The method according to claim 1, wherein ascertaining the at least one parameter is effected by means of data from at least one element of the motor vehicle, selected from the group comprising an electromagnetic sensor, an acoustic sensor, a rotational speed sensor, an acceleration sensor, an optical camera, a vehicle-to-vehicle communication device, a vehicle-to-infrastructure communication device and a driver assistance system.

10. The method according to claim 1, wherein ascertaining the at least one parameter includes ascertaining a current position of the motor vehicle and wherein classifying the momentary traffic situation of the motor vehicle is effected based on the ascertained position and on data stored in a storage device.

11. The method according to claim 1, further comprising:
ascertaining at least one of current weather conditions in the vicinity of the motor vehicle and a time of day,
wherein adapting the triggering threshold is effected depending upon at least one of the ascertained current weather conditions and the ascertained time of day.

12. The method according to claim 1, further comprising:
ascertaining at least one of a type and a speed of an object involved in a possible impending accident,
wherein adaptation of the triggering threshold is effected depending upon at least one of the ascertained type and the ascertained speed.

13. The method according to claim 1, further comprising:
ascertaining an alignment of the motor vehicle in relation to a carriageway driven over by the motor vehicle,
wherein adaptation of the triggering threshold depending upon the ascertained alignment is effected.

14. A safety system for a motor vehicle comprising:
a first ascertainment device that ascertains at least one parameter characterizing a traffic situation of the motor vehicle;
a classification device that classifies a momentary traffic situation of the motor vehicle based on at least one ascertained parameter;
a second ascertainment device that ascertains a probability for an occurrence of at least one accident type from a plurality of predefined accident types in the classified momentary traffic situation; and
an adaptation device that adapts a triggering threshold for actuating at least one passenger protection device of the motor vehicle, in case the ascertained probability exceeds a predefined threshold value.

15. A computer program product, comprising:
a non-transitory computer readable medium readable by a computer unit of a motor vehicle and storing instructions for execution by the computer unit for performing a method comprising:
ascertaining at least one parameter characterizing a traffic situation of the motor vehicle;
classifying a momentary traffic situation of the motor vehicle based on at least one ascertained parameter;
ascertaining a probability for an occurrence of at least one accident type from a plurality of predefined accident types in the classified momentary traffic situation; and
in case the ascertained probability exceeds a predefined threshold value, adapting a triggering threshold for actuating at least one passenger protection device of the motor vehicle.

16. The computer program product according to claim 15, wherein the method further comprises:
ascertaining a probability for the occurrence of an accident type is effected for all of the plurality of predefined accident types in the classified momentary traffic situation.

17. The computer program product according to claim 15, wherein adaptation of the triggering threshold is effected such that actuation of the at least one passenger protection device is effected at an earlier point in time.

18. The computer program product according to claim 15, wherein the plurality of predefined accident types includes at least one element selected from the group comprising a frontal collision, a rear-end impact, a lateral collision, a rear-end accident, a skidding accident, an accident with a stationary object, a collision with a pedestrian, an accident involving wildlife, a rollover accident and a departure from the carriageway.

19. The computer program product according to claim 18, wherein the at least one passenger protection device of the motor vehicle is selected from the group comprising a belt tensioner, an airbag, an active head support system, a seat adjustment system, a foldable pedal set and a safety steering column.

20. The computer program product according to claim 15, wherein the method further comprises:
ascertaining at least one of current weather conditions in the vicinity of the motor vehicle and a time of day,
wherein adapting the triggering threshold is effected depending upon at least one of the ascertained current weather conditions and the ascertained time of day.
